(19) United States
(12) Patent Application Publication
(10) Pub. No.: US 2019/0385463 A1
(43) Pub. Date: Dec. 19, 2019

(54) SYSTEM AND METHOD FOR MANAGING TRAFFIC FLOW OF UNMANNED VEHICLES

(71) Applicant: Walmart Apollo, LLC, Bentonville, AR (US)

(72) Inventors: Robert CANTRELL, Herndon, VA (US); Donald R. HIGH, Noel, MO (US); John J. O'BRIEN, Farmington, AR (US); John SIMON, Pembroke Pines, FL (US); Brian MCHALE, Oldham (GB)

(73) Assignee: Walmart Apollo, LLC, Bentonville, AR (US)

(21) Appl. No.: 16/431,059

(22) Filed: Jun. 4, 2019

Related U.S. Application Data
(60) Provisional application No. 62/685,548, filed on Jun. 15, 2018.

(51) Int. Cl. G08G 5/00; G05D 1/10; G05D 1/02; H04W 4/44; G08G 5/04; G06Q 50/28

(52) U.S. Cl. CPC G08G 5/0034; G05D 1/1064; G05D 1/0289; G06Q 50/28; G08G 5/04; G08G 5/0039; G08G 5/0021; H04W 4/44

(57) ABSTRACT

The present invention is directed to systems and methods for managing traffic one or more unmanned vehicles. A traffic flow managing system can include: a plurality of unmanned vehicle, each of the plurality of the unmanned vehicle comprising: a processor having executable instructions stored in a non-transitory computer-readable storage medium; and one or more sensors in communication with the processor, wherein the processor is configured to: detect any other unmanned vehicles approaching the unmanned vehicle within a predetermined distance via one or more sensors, communicate with any other unmanned vehicles to create a buffer zone around the unmanned vehicle to avoid entering the buffer zone of any other unmanned vehicles, and determine a route of the unmanned vehicle to a mission destination based on a signal received by the one or more sensors of the unmanned vehicle.

### CROSS REFERENCE TO RELATED APPLICATION

This patent application claims the benefit of U.S. Provisional Application No. 62/685,548, filed Jun. 15, 2018, the contents of which is incorporated by reference herein.

### BACKGROUND

### 1. Technical Field

The present disclosure relates to managing traffic flow of one or more unmanned vehicles, and more specifically to systems and methods for the unmanned vehicles to independently manage the traffic flow.

### 2. Introduction

Typically, a central server operating an Unmanned Traffic Management (UTM) system is simultaneously in communication with a number of unmanned vehicles, such as unmanned aerial vehicles (UAVs) (e.g. drones) and unmanned ground vehicles (UGVs) (e.g. robots), for command, control, and situational awareness. Accordingly, in operation, the central server may determine an appropriate route for each unmanned vehicle and continually monitor a location of each unmanned vehicle. Each unmanned vehicle in turn may communicate performance characteristics to the central server so that the central server can issue commands that the unmanned vehicle can follow. The central server must make an unlimited amount of decisions for all unmanned vehicles at any given point in time. As a result, load on the central server to handle the traffic flow of all unmanned vehicles is very high. Therefore, the central server may not be sufficiently flexible or powerful to efficiently handle such a number of possibilities and complex situations.

### SUMMARY

An example traffic flow managing system configured according to the concepts and principles disclosed herein can include: a plurality of unmanned vehicles, each of the unmanned vehicle comprising: a processor having executable instructions stored in a non-transitory computer-readable storage medium; and one or more sensors in communication with the processor, wherein the processor is configured to: detect any other unmanned vehicles approaching the unmanned vehicle within a predetermined distance via one or more sensors, communicate with any other unmanned vehicles to create a buffer zone around the unmanned vehicle to avoid any other unmanned vehicles from entering the buffer zone, and determine a route of the unmanned vehicle to a mission destination based on a signal detected by the one or more sensors of the unmanned vehicle.

An example computer-implemented method of managing traffic flow of a plurality of unmanned vehicles disclosed herein can include: receiving, by a first unmanned vehicle, a mission destination for travel; creating, by the first unmanned vehicle, a first buffer zone around the first unmanned vehicle that a secondary unmanned vehicle is prohibited from entering based on one or more sensors of the first unmanned vehicle; and determining, by the first unmanned vehicle, a route for the first unmanned vehicle based on a signal detected from the one or more sensors that enters the first buffer zone around the first unmanned vehicle.

Another example traffic flow managing system configured according to the concepts and principles disclosed herein can include: a central server; a plurality of sensors arranged in a localization grid inside a store; a plurality of unmanned vehicles, each of the plurality of the unmanned vehicles comprising: a processor having executable instructions stored in a non-transitory computer-readable storage medium; and one or more sensors in communication with the processor, wherein the processor is configured to: detect any other unmanned vehicles approaching the unmanned vehicle within a predetermined distance via one or more sensors, communicate with any other unmanned vehicles to create a buffer zone around the unmanned vehicle to avoid any other unmanned vehicles from entering the buffer zone, and determine a route of the unmanned vehicle to a mission destination based on a signal detected by the one or more sensors of the unmanned vehicle.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of this disclosure are illustrated by way of an example and not limited in the figures of the accompanying drawings, in which like references indicate similar elements and in which:

FIG. 1 is a diagram illustrating an example environment comprising a plurality of unmanned vehicles in accordance with some embodiments of the present invention;

FIG. 2 is a diagram illustrating an example unmanned vehicle in accordance with some embodiments of the present invention;

FIG. 3 is a diagram illustrating an exemplary boundary surrounding an unmanned vehicle in accordance with some embodiments of the present invention;

FIG. 4 is a diagram illustrating an exemplary buffer zone surrounding an unmanned vehicle in accordance with some embodiments of the present invention;

FIG. 5 is a diagram illustrating a plurality of drones managing traffic in accordance with some embodiments of the present invention;

FIG. 6 is a diagram illustrating an example of two swarms of drones managing traffic in accordance with embodiments of the present invention;

FIG. 7 is a flowchart diagram illustrating a simulation process for managing traffic flow of the unmanned vehicles in accordance with some embodiments of the present invention;

FIG. 8 is a flowchart diagram illustrating a drone navigation process related to drone maneuverability in accordance with some embodiments of the present invention; and

FIG. 9 is a block diagram an example computer system in which some example embodiments may be implemented.

It is to be understood that both the foregoing general description and the following detailed description are example and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

The systems and methods disclosed herein localize traffic control by the unmanned vehicles themselves. The systems may utilize onboard or off-board sensors to detect the unmanned vehicles within a distance of each other. The traffic flow of the unmanned vehicles may be managed when the unmanned vehicles are in flight or are on-ground. The unmanned vehicles may be of any type, such as drones navigating in the air or UGVs moving within a retail store or warehouse. As will be discussed in more detail below, although the unmanned vehicles may be in communication with a central server, they can monitor their local situations and handle traffic control themselves to determine how they are going to move in order to complete their missions safely. Each of the unmanned vehicles may act in effect as a local UTM system and manage traffic independently without assistance of the central server or a central UTM system.

Further, the sensors may create a buffer zone for each unmanned vehicle to detect other unmanned vehicles within the buffer zone that other unmanned vehicles should not enter. The buffer zone may vary in shape and size based on unmanned vehicle parameters. The unmanned vehicles can determine how to maneuver around each other themselves, for example based on a rule set.

The central server may monitor positions of the unmanned vehicles in an area by tracking the routes or trajectories of the unmanned vehicles and determine appropriate maneuvering in providing rerouting for the unmanned vehicles. In some embodiments, the central sever may receive the routes and position information from the unmanned vehicles and perform forward simulation in order to send alerts to the unmanned vehicles which may collide with each other based on their current and projected paths.

Embodiments of the present disclosure provide systems and methods for unmanned vehicles to handle traffic flow independently and to self-navigate to their destinations safely in an efficient and flexible manner. Each unmanned vehicle can monitor local traffic automatically and independently self-navigate to complete a mission. Each unmanned vehicle can follow a common set of navigating rules, choose its preferred route, and handle traffic as it comes. The system may function safely without command and control by the central UTM or with the central server. The central server or central UTM system may work as a backup. The system evolves closer to an ideal situation of receiving all the benefits of the central UTM but without depending on the central UTM for command and control.

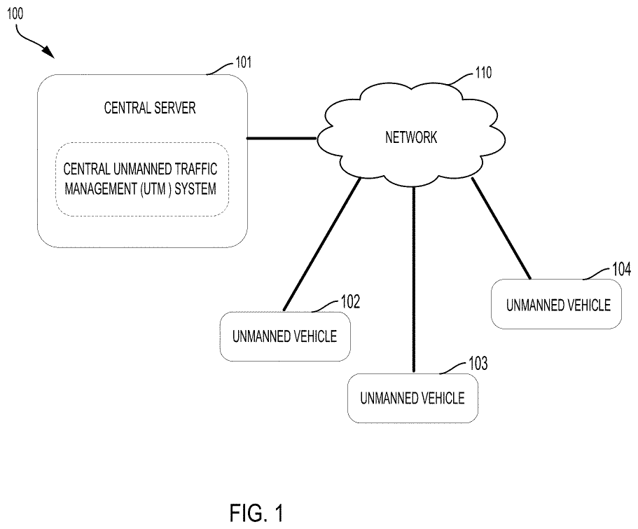

FIG. 1 is a diagram illustrating an example system 100 in which some embodiments may be implemented. As illustrated, the example system 100 generally includes central server 101, a plurality of unmanned vehicles 102-104, and network 110.

The central server 101 may be implemented as a computing infrastructure of one or more servers and databases including processors, memory (data storage), software, data access interface, and other components that are accessible via various type of wireless or wired networks. One or more servers and databases, are shown and referred to as the central server 101 for simplicity. The central server 101 may be as a network-accessible computing device to monitor and manage the unmanned vehicles. The central server 101 may be located in a distribution center and/or a retail store. Furthermore, the central server 101 may include one or more processors and memory which may be utilized to operate a central UTM system. The central UTM system may be configured via the central server 101, for example, to perform route monitoring and to generate navigation instructions for the unmanned vehicles, etc.

In the example system 100, the network 110 may be a mesh network and include satellite-based navigation system or a terrestrial wireless network, Wi-Fi, and other type of wired or wireless networks to facilitate communications between the various networks devices associated with the example system 100. For example, the communications may send navigation instructions or other commands to the unmanned vehicles to control the operation and navigation of the unmanned vehicles. The communications may provide information to and receive information from the unmanned vehicles. The unmanned vehicles may communicate amongst themselves to form the mesh network.

In some embodiments, the central server 101 may be in communication with unmanned vehicles at local ground stations or unmanned vehicle distribution centers (not shown) for unmanned vehicle traffic control. The central server 101 may process navigation requests for the unmanned vehicles, generate and provide mission instructions to the unmanned vehicles, and access a database to coordinate safe unmanned vehicle navigation in an area. Moreover, the central server 101 may process the unmanned vehicle route information and receive real-time navigation status from an unmanned vehicle. The central server 101 may be configured to monitor each of the plurality of the unmanned vehicles and wirelessly communicate with the unmanned vehicles. For example, each unmanned vehicle may wirelessly send initial Global Positioning System (GPS) position information (e.g. latitude X, longitude Y, and altitude Z), images, flight path information, and/or other data to the central server 101. Likewise, the central server 101 may wirelessly send navigation instructions and/or other commands to the unmanned vehicle.

The central server 101 or the central UTM system may track the positions and trajectories of the unmanned vehicles from GPS, beacon, transponder, or other tracking technology, and alert the unmanned vehicles to change their routes in order to avoid conflict. The UTM system may collect data associated with all of the unmanned vehicles navigating in an area.

In some embodiments, an unmanned vehicle may receive a mission instruction from the central server 101 or other computing devices and navigate to the destination itself. For example, the central server 101 can transmit mission or task instructions to the unmanned vehicles 102-104. The mission instructions (e.g. mission information data) for the unmanned vehicles may comprise mission origin, destination, package weight, package capacity, etc.

Upon receiving the mission instructions and/or other commands, the unmanned vehicles 102-104 may determine how to travel to their destinations or delivery locations themselves. In traveling to their destinations, the unmanned vehicles 102-104 may have one or more navigation rules to follow, as will be discussed in more detail below, to not collide with each other or with other objects. The navigation rules can be pre-loaded onto the unmanned vehicles 102-104.

The unmanned vehicle may navigate safely in a most efficient route to a destination and back from that route any time it wants, with ample sensory equipment to see all other unmanned vehicles within its area and take corrective actions as required. Accordingly, the unmanned vehicles 102-104 may each determine an efficient route to their destinations to perform the mission and act independently from one another. As such, the central server 101 does not need to make appropriate determinations for the unmanned vehicles 102-104 while they travel to their destinations. The central server 101 may receive the real-time unmanned vehicle flight information from the unmanned vehicles. In some embodiments, the operational parameters of the unmanned vehicle may comprise GPS information, flight heights, speeds, route, unmanned vehicle weight, package weight, package capacity, battery level, direction, air speed, weather conditions, etc.

However, the central server 101 can serve as a backup in case one of the unmanned vehicles 102-104 is unable to make an appropriate determination when traveling to its destination. Moreover, the central server 101 may work in parallel with the unmanned vehicles to provide control and alerts to ensure appropriate determinations and operations.

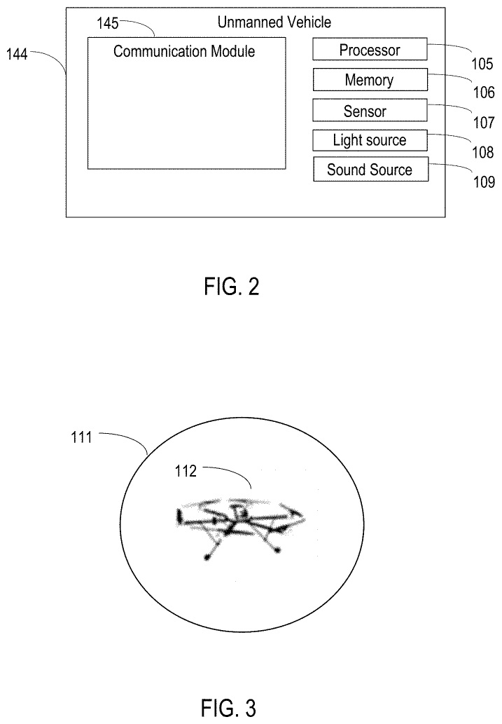

FIG. 2 is a block diagram of an example unmanned vehicle 144 in which some example embodiments may be implemented. The unmanned vehicle 144 can comprise a communication module 145 to communicate with the central server 101 and other unmanned vehicles. The unmanned vehicle 144 may comprise a processor 105, a memory storage device 106 in communication with the processor 105 for storing the instructions to be executed by the processor 105, and one or more sensors 107 in communication with the processor 105 and memory storage device 106.

The sensors 107 of the unmanned vehicle 144 can be configured to detect a wavelength of sound, and/or to detect a wavelength of light. The sensors 107 can include a light sensor and/or a sound sensor. The light sensor may detect a wavelength of light from another unmanned vehicle and may be configured to detect light having different predetermined wavelength ranges which represent different colors. The sound sensor may detect a wavelength of sound from another unmanned vehicle and may be configured to detect a sound within one of a plurality of predetermined ranges. Likewise, the unmanned vehicle 144 can include a light source 108 and/or a sound source 109, each of which is in communication with the processor 105. The light source 108 can transmit a light of a selected wavelength, and the sound source 109 can transmit sounds. As such, the light source 108 and/or sound source 109 can be utilized to ensure that other unmanned vehicles or objects do not enter the buffer zone of the unmanned vehicle 144.

The light sensor may detect one or more properties of light, including dispersed light, light intensity, apparent size of light, sensitivity of light, and pulse of light. The properties may be representative of whether an object is approaching or retreating from the unmanned vehicle 144. For example, an increase of light, or of apparent size of light, may represent an unmanned vehicle or object approaching. Along these lines, a decrease of light intensity, or of apparent size of light, can represent an unmanned vehicle or object retreating.

In one embodiment, an unmanned vehicle may detect any other unmanned vehicles approaching within a predetermined distance via one or more sensors. The sensors of an unmanned vehicle may create a buffer zone around it such that other unmanned vehicles do not enter each other's buffer zone. One unmanned vehicle may detour and maneuver appropriately when another unmanned vehicle is about to enter its buffer zone or if it is about to enter a buffer zone of another unmanned vehicle. Moreover, an unmanned vehicle may determine a route to a mission destination based on a signal detected by the one or more sensors. The unmanned vehicle may be configured to perform self-navigation independent from the central server.

In some embodiments, the unmanned vehicle 144 may be equipped with radar and a transponder to facilitate communications with other unmanned vehicles.

The communication module 145 may allow the unmanned vehicle 144 to communicate with computing devices or processors in the example system 100. The communication module 145 may utilize cellular, radio frequency, near field communication, infrared, Bluetooth, Wi-Fi, satellite, or any other means for communications. According to one embodiment, the unmanned vehicle 144 may include video cameras and/or infrared cameras with both visual and infrared spectra, Lidar sensors, laser altimeter, visual sensors, and other types of sensing system. These cameras and/or sensors may be placed on the unmanned vehicle 144. The unmanned vehicle 144 may be configured to take pictures/video of the navigation routes in real-time and send the data to the central server.

The unmanned vehicle 144 may further include GPS module, navigation module, power module, and other mechanical components. The GPS module and navigation module may be used for determining position information of the unmanned vehicle 144, guiding the unmanned vehicle 144 navigating to the destination, and conducting specific functions or data analysis.

In some embodiments, decision making is conducted by the local processors of the unmanned vehicles to allow the unmanned vehicles to independently and more quickly control their own operations. An individual unmanned vehicle may monitor its local situation, follow a common set of navigating rules, choose its preferred route and handle air traffic as it comes. Without the need of a central server for command and control, the problems associated with a central server are solved.

In some embodiments, systems and methods for managing traffic of one or more unmanned vehicles may be disclosed. Referring back to FIG. 1, the unmanned vehicles 102-104 may be made highly visible to each other by emitting various wavelengths and detecting wavelengths in forms of light or sounds emitted by other unmanned vehicles. Their onboard sensors and computing devices are able to process their parameters associated with the dynamic environment much faster and more accurately than a human being can. The unmanned vehicles may handle traffic as it comes by following common rules, such as right-of-way priority. For example, the unmanned vehicles may automatically navigate from a point A to a point B without pre-registering their routes and central control.

The central UTM system may manage the high numbers of unmanned vehicles simultaneously, and track the positions and trajectories of the unmanned vehicles. The UTM system may be standardized so that all types of the unmanned vehicles may easily communicate with the UTM system or receive commands and alerts from the UTM system. The unmanned vehicles in turn may communicate performance characteristics to the UTM. Thus, the central server may exist and serve as a backup, additional supplement, or a primary control at central hubs such as a port for the unmanned vehicles.

The central UTM system may maintain a database of tasks, priorities, assignments and congested areas, which may continually be updated.

FIG. 3 illustrates an exemplary boundary surrounding a drone in accordance with embodiments of the present disclosure. A buffer zone 111 created by the onboard sensor of a drone 112 may entirely surround the drone 112. The buffer zone 111 can emulate a 360° bubble around the drone 112 and the sensor can detect signals from any other drones or objects. The buffer zone 111 may relate to a space that other drones or objects are prohibited to enter. As will be described in more detail below, in response to other drones or objects approaching the drone 112, the drone 112 and/or the approaching drone or object may make an appropriate mutual decision regarding a route. An unidentified flying object may be accounted as being in the buffer zone 111 so that the drone 112 can make an appropriate route change.

A size of the buffer zone 111 surrounding at least a portion of the sensor can be based on the equation of I∝1/d², wherein “I” represents intensity of the light that can be detected by the sensor of the drone 112 and “d” representing the distance of coverage surrounding the sensor of the drone 112. Moreover, the size of the buffer zone 111 can be dynamically adjusted based on one or more properties of the drone 112 and/or another drone or object. The properties of the drone 112 may include a speed of the drone 112, an expected speed of other drone or object, and an expected number of other drones or objects within a vicinity of the drone 112.

Moreover, the size of the buffer zone 111 can correlate to the wavelength that the sensor of the drone 112 may detect. That is, a drone can create an buffer zone (e.g. local UTM bubble) around itself of waveform such as light spectrum at an intensity proportional to the distance away from the center of emanation by which an area space around it and other drones become no-enter zones based on I∝1/d².

In one example, the drones may bump up to the bubble but do not navigate through it, and then evade each other by mutually expedient routes based on navigation rules. Such a visually oriented bubble is observable by watching gatherings of drones. For example, even two drones that may be on a collision course seem to know which way to break, (e.g., left, right, up, or down), depending on a slight deviation from a center of their approach and the presence of other drones. The drones do not run into each other. The drones can independently navigate to and reach their end destinations by selecting the most efficient flight paths within allowable flight space. The UTM system may operate as a backup system without providing routing command and control for the drones.

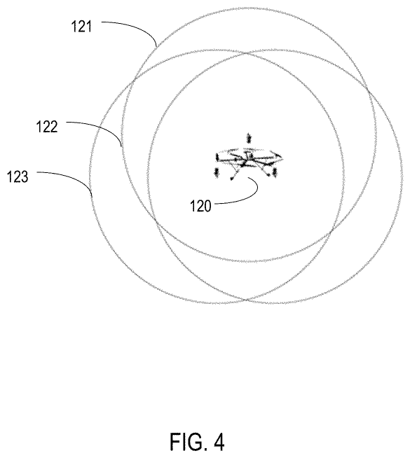

Referring to FIG. 4, the exemplary buffer zones 121-123 with multiple sensors (not depicted) on an unmanned vehicle such as a drone 120 are illustrated. The buffer zones 121-123 can be mutually inclusive. Each of the three buffer zones 121-123 can partially overlap. By overlapping the buffer zones 121-123, the drone 120 can have a buffer zone greater than each of the buffer zones 121-123 individually. The buffer zone surrounding the drone 120 may be called the local UTM bubble, which may dynamically vary in shape and size in the different situations. For example, the buffer zone may be a sphere, but not necessarily a perfect sphere. The buffer zone may be more egg shaped than a perfect circle to give more reaction space for the individual drone to its front, in order to reflect a greater concern and distance monitored for drones in or near the path of travel, rather than those drones already passed.

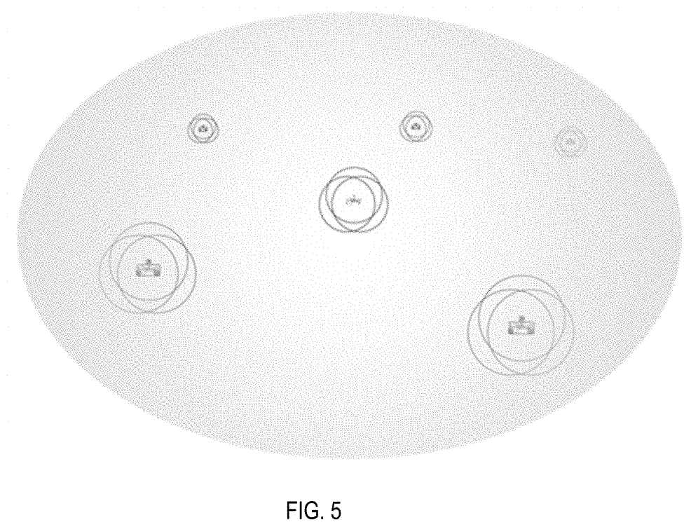

FIG. 5 is a diagram illustrating a plurality of drones managing traffic in some embodiments. FIG. 5 shows buffer zones of a swarm of drones with different sizes. The drones may emit wavelengths with different frequencies and be shown as different colors in FIG. 5. In some embodiments, each of the buffer zones of a first drone can partially overlap each other to make a first local UTM bubble. The buffer zones of a second drone can partially overlap each other to make a second local UTM bubble.

When the first local UTM bubble overlaps the second local UTM bubble, each drone sends and receives flight information data to and from other drones within its bubble. Moreover, each drone can still operate individually and navigate properly as an individual local UTM system. The principle of the system operation works the same as that of drivers in cars who monitor the sphere around their cars. An optimal configuration of a buffer zone for a drone is that the appropriate size of the buffer zone may be based on the performance of the drone and other drones so that each drone can observe, orient, determine its route, and navigate safely.

Wavelengths displayed by the light sources of the drone may be visible within the drone bubble depending upon such elements as speed and direction changes of the drone. This information can be communicated via wavelengths detected by the sensors of the drone even without communicating between the drones via the network.

In some embodiments, the drone may use the color (frequency) of the light to indicate when the drone is speeding up, slowing down, increasing altitude, decreasing altitude, turning left, turning right, stopping, etc. LED lights may be used to transmit digital messages from one drone to another. Drones sharing the same color may travel at the same altitude. Drones emitting different colors may navigate at different altitudes and in different directions. In principle, drones with a similar size may naturally seek each other out and travel together.

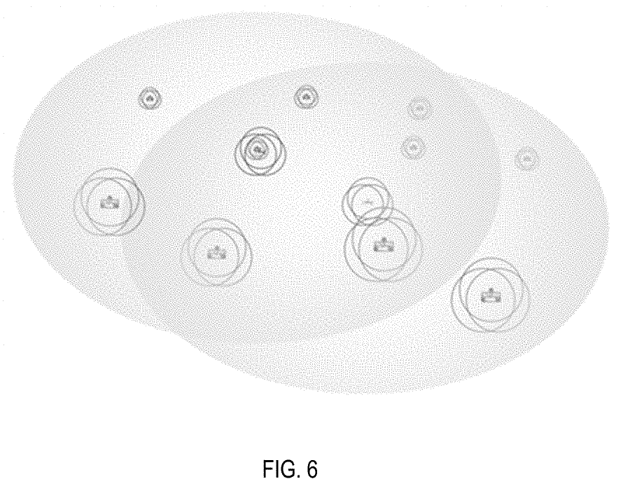

FIG. 6 is an example of two swarms of a plurality of drones. Each of the drones of the swarm can be in communication with each other. By communicating with each other, the drones can share a route and jointly make appropriate steering maneuvers. The drones can make appropriate steering maneuvers at a same point in time, and can do so without separating from each other.

Furthermore, while traveling together in the swarm, each of the drones can employ one buffer zone for detecting a wavelength of sound and/or light. By employing buffer zones, when traveling and making various steering maneuvers, the drones can ensure not to travel and enter in a buffer zone around each of them. Additionally, each swarm may have its's own cumulative buffer zone encompassing each of the individual buffer zones of the drones in the swarm. Each cumulative buffer zone of the swarm can represent airspace which no other objects can enter.

Flocking rules may be employed as a model for how drones may behave when traffic becomes particularly dense. Swarm rules may be employed when the traffic is less dense and uncooperative. Each drone may navigate independently and safely within its buffer area. That is, the drone has its own individual no-fly sphere that no other drone can enter. Or the no-fly sphere becomes the edge at which drones may logic-train with each other, working in principle to flocking rules where individuals maintain spacing. The drones may sense and avoid elements or more advanced along the navigation path of travel than side-to-side or rear. Drones travelling together may convey where the drone on a given side front or rear leaves the other drones invulnerable from that quarter, and all benefit by having at least one corner less exposed.

The drones may see the full scope of their environment with the sensors to make themselves visible and known. Each drone can navigate independently in the presence of others with near zero risk of colliding. This may include communication between the drones so that a local UTM system on one drone can see through a nearby drone with onboard sensors and computing devices, possibly leveraging what the nearby drone sees so there are no blind spots.

In some embodiments, every sensor and local UTM system that a drone uses to detect another drone may be paired with an emitter or reflector that facilitates detecting drones successfully. In one embodiment, there is a respective set of emitters or reflectors to assist the corresponding detection system in successfully making the detection.

In one embodiment, a central server may be configured to monitor a group of drones and their local UTM bubbles as backup and for data collection. Even without command and control from the UTM system or the central server, the drones can communicate with the central server with the updated information including positions and trajectories of the drones. The central server may include a route forward simulation module to predict and simulate the route condition based on the circumstance data. The circumstance data may include the positions and trajectories of all drones in a UTM bubble, overlapping bubbles, or another collection of unmanned vehicle presence and trajectory information in an area. The buffer zones or the local UTM bubbles of the drones may stretch into time by locally or being mapped on a central server running a forward simulation. In some embodiments, the central server or the UTM system may apply predetermined routing or navigational rules to drones in decision making. The predetermined routing or navigational rules may include a buffer zone, communication rules, mission instruction or task transfer, task priority level, vehicle temperature, travel time, etc.

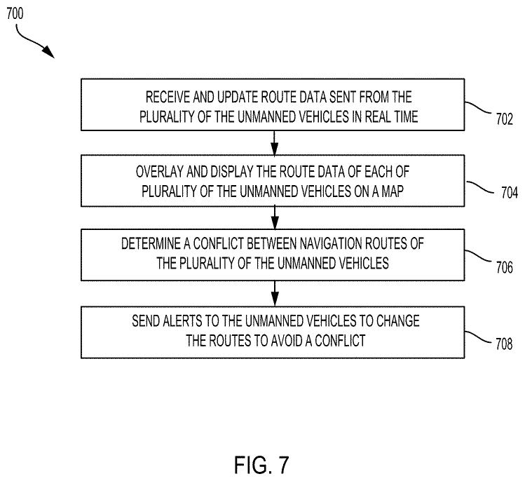

FIG. 7 is a flowchart diagram illustrating a forward simulation process 700 for managing traffic flow of unmanned vehicles in accordance with some embodiments.

At step 702, a central server may receive and update route data sent from the plurality of the unmanned vehicles in real time. Each of the plurality of the unmanned vehicles may communicate with the central server by transmitting a route data. The route data may comprise GPS information, a destination, a task, a task priority level, a navigating speed, a navigating direction, a battery level, and an operating temperature, etc. The central UTM system may monitor the routes of the unmanned vehicles and keep updating the data in real time.

At step 704, the central server may overlay and display the route data of each of the plurality of the unmanned vehicles. In some embodiments, the central server may use the route forward simulation module to predict and simulate the route condition based on the received route data. The received route data may include the positions and trajectories of all related drones in a UTM bubble, overlapping bubbles, or another collection of unmanned vehicle presence and trajectory information in an area. The central server may calculate, predict, and map the navigation route for each unmanned vehicle in the forward simulation module.

At step 706, the central server may determine a conflict between navigation routes of the plurality of the unmanned vehicles in an adjustable time interval. The central server may be configured to decide whether the navigation routes between the plurality of the unmanned vehicles will be intersected with each other in a specific time interval based on the received route data. In some embodiments, the simulation may show how the unmanned vehicles are moving and may predict what may happen five, ten, fifteen or more seconds out.

At step 708, the central server may send alerts to the unmanned vehicles for them to change the routes to avoid a conflict. For example, if a collision happens in the forward simulation, it may presumably happen in real life a few seconds later. Alerts or warnings may be given to some specific unmanned vehicle to avert the future collision. This gives the unmanned vehicle a potential reaction time to avoid the collision.

In some embodiments, the traffic managing system has defined flight rules and rights of ways for the drone, so that maneuver errors from simultaneous independent decisions do not occur.

The flight rules of the drone can refer to prescribed regulations for operating during traveling to a destination, and/or more particularly, for acting in a particular situation in route to the destination. Drone flight rules may include a buffer zone, communication rules, mission instruction or task transfer and related to traffic, weather, task priority, landing rules, destination, etc. The drones may automatically navigate and independently communicate with other drones nearby based on the flight rules by defining the buffer zone around each drone.

Navigation rules may affect speed of a drone. When traffic density increases, top speed of the drone may decrease in order to maintain a constant and acceptable risk profile overall. Drone speeds may be controlled to be reasonable and proper according to the conditions.

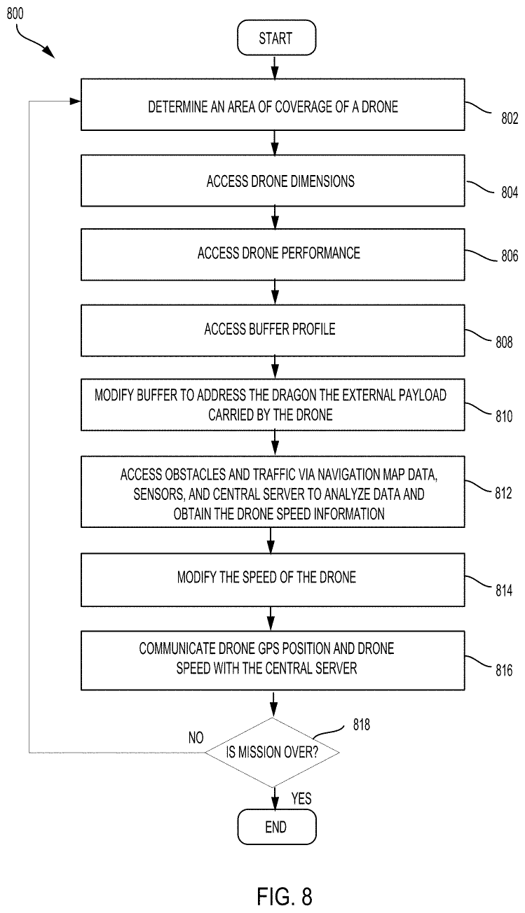

FIG. 8 is a flowchart diagram illustrating a drone navigation process 800 related to drone maneuverability in accordance with some embodiments. It will be appreciated that the process 800 is implemented by one or more computer-executable processes executing by a processor, or in communication with, one or more servers described. The process 800 may be implemented in the above described systems and may include the following steps. Steps may be omitted or combined depending on the operations being performed.

The drone may first receive the mission instructions from the central server or other computing devices. The mission instructions may comprise mission origin, mission destination, package weight, package capacity, operational parameters of the drone, etc. In some cases, the mission instructions may include an identification and location of a package for pick-up, and an identification and location of the destination.

The example process 800 begins at 802 by determining a preliminary buffer zone for the drone. The preliminary buffer zone may be a default value.

The buffer zone surrounding the drone may be created by a drone processor based on the intensity of the light detected by the sensors of the drone. The size of the buffer zone surrounding the drone may be measured on a particular wavelength of light emitted from other drones. The drone may be preloaded with one or more navigation rules before performing navigation. The buffer zone of the drone may be varied during the navigation in order to give ample stopping or maneuver room for the drone to address hazards while prohibiting other drones entering the buffer zone, as described below.

At step 804, the processor may access drone dimensions, such as weight, size, etc.

At step 806, the processor may access drone performance at speed Pₛ. The drone performance at speed may be related to drone parameters, such as speed, agility, stopping features, and load modifiers.

At step 808, the processor may calculate drone performance at speed Pₛ using an equation (1) of drone energy maneuverability. The equation (1) is used to describe the drone performance at speed. It relates speed V, thrust T, weight W, aerodynamic drag D.

P_{S}=V((T−D)/W) (1)

where:

P_{S}=Performance at speed

V=Velocity

T=Thrust

D=Drag

W=Weight.

At step 810, the processor may modify the buffer zone to address the drag on an external payload (box) carried by the drone using drag calculations given by equation (2).

D=Cd*A*0.5*r*V² (2)

where:

D=Drag

Cd=Drag Coefficient

A=Reference area

r=Density [or the air in this instance]

V=Velocity.

At step 812, the processor may assess obstacles (or other drones) and traffic via navigation map data, sensors, and central server or the central UTM to analyze data and obtain the drone speed information.

At step 814, the processor may modify the navigation speed V based on equation (3) by selecting a minimum value between the fastest safe speed of the drone and the fastest allowed speed of the drone.

V=min{a,b} (3)

where:

a=fastest safe speed of the drone

b=fastest allowed speed of the drone.

At step 816, the drone may communicate with the central server or the central UTM during navigating to the destination and wirelessly send the drone flight information in real-time to the central server or the central UTM including GPS coordinates (latitude x, longitude y, and altitude z) and drone speed V.

At step 818, the drone processor may determine whether the mission is over. Upon determining the mission is over and the drone reaches the destination, the process ends. Upon determining the mission is not over, the drone processor may continue to check and update the buffer zone based on the present navigation situation.

In some embodiments, the above described system and method of managing the traffic flow of the unmanned vehicles can be utilized for coordinating the movements and missions within an indoor environment. In such case, a network of sensors may be provided to determine the unmanned vehicles location, for example, in a retail store.

Referring back to FIG. 1, the example system 100 may include central server 101, a plurality of unmanned vehicles 102-104, a localization grid comprising sensors, and network 110. A localization grid comprising sensors distributed within the environment can be used to detect where an unmanned vehicle is or allow the unmanned vehicle to detect where it is within the indoor environment. The system may further include store mounted cameras, WIFI hotspots, LTE signal boosters, to provide information about the environment and determine the areas with the most human traffic. The system may utilize active detecting equipment, such as a light, passive sensor, and reflector, etc.

In some embodiments, the unmanned vehicles may be UGVs in communication with the central server or other computing devices located inside a retail store.

The actions taken by an unmanned vehicle may be one or more predetermined navigational rules which may be stored within memory of the unmanned vehicle. In some embodiments, unmanned vehicle routing or navigational rules may be based on a buffer zone, communication rules, mission instruction or task transfer, task priority level, vehicle temperature, etc.

The unmanned vehicles may have different functionalities, for example a case sorting conveyor unmanned vehicle, an autonomous floor cleaning unmanned vehicle, a shelf scanning unmanned vehicle, an unmanned vehicle for returning products to shelves, an unmanned vehicle for transporting pallet loads of product, etc. Moreover, tasks may be assigned to the unmanned vehicles with pre-determined priority levels. In some embodiments, the system may use the task priority level of the mission as an input in the decision-making process. Priorities may be pre-determined as follows:

1) frozen product being transported to customer;
2) refrigerated product being transported to customer;
3) ambient product being transported to customer;
4) out of Stock product being transported to sales floor;
5) returned product being transported sales floor;
6) normal stock product being transported sales floor;
7) floor being cleaned; and
8) normal inventory scan.

In one embodiment, the central server 101 may transmit mission instructions to the unmanned vehicles 102-104. The central server may receive real-time unmanned vehicle route data from the unmanned vehicle. The route data may include unmanned vehicle operational parameters and status such as GPS information, unmanned vehicle task status (e.g. task completed, on-duty), battery information, direction, speed, human traffic status, etc.

The navigation rules can be pre-loaded onto the unmanned vehicles by the central server 101 or an external computing device. Each unmanned vehicle may communicate with other nearby unmanned vehicles, store associates and even autonomous outdoor or road vehicles. An overarching command and communication system can facilitate the coordination of tasks, assignments, routing, and obstacle avoidance.

In some embodiments, when the first local UTM bubble overlaps the second local UTM bubble, each unmanned vehicle sends and receives route data to and from other unmanned vehicles within its bubble. In one embodiment, to avoid conflicts or collisions, the mission priority levels of both unmanned vehicles may be compared by each of unmanned vehicles. The unmanned vehicle with a lower mission priority level may change its route or stop to delay the start time of its mission. The central server 101 may change the route of an unmanned vehicle or delay the start time of its mission based on the mission priority level of the unmanned vehicles. The unmanned vehicle may automatically navigate and independently communicate with other unmanned vehicle nearby based on the navigational rules by defining the buffer zone around each unmanned vehicle. For example, when an unmanned vehicle for transporting pallet loads of product drops off a pallet, its buffer zone (e.g. bubble size) may reduce accordingly.

In one embodiment, the central server 101 will overlay the planned routes for the unmanned vehicles and determine where conflicts may arise. To avoid these conflicts, the central server 101 may use the priority of the mission as an input to the decision-making process. For example, the central server 101 may wirelessly send a command to the unmanned vehicle with a lower task priority to change the route or delay its start time. Each drone may still operate individually and navigate properly as an individual local UTM.

The UTM system may maintain a database of tasks, priorities, assignments and congested aisles, which may continually be updated. The unmanned vehicles will report obstacles and congested conditions to the central server 101 or the UTM system. The unmanned vehicle may be rerouted dynamically based on signals received from sensors. For example, the unmanned vehicle may reroute, change a velocity and/or acceleration during traveling along an aisle based on the received signals from the sensors.

The central UTM system may use machine learning with a feedback loop to instruct the unmanned vehicles on more efficient methods. In one embodiment, packaging designs may be altered to accommodate unmanned vehicle handling (based upon end effector configurations and transport).

Moreover, obstacles to the unmanned vehicles may be static, dynamic, temporary or permanent. In one embodiment, the operating temperature of the unmanned vehicle may be required to consider since an unmanned vehicle temperature is related to the unmanned vehicle battery and may affect battery life. For Example, when the unmanned vehicle detects the battery percentage of the unmanned vehicle is lower than the predetermined battery percentage (e.g. 10%), the unmanned vehicle may automatically navigate to a nearby charging station for battery charge. In another example, when the unmanned vehicle detects unmanned vehicle temperature is higher than a predetermined level, the unmanned vehicle may automatically slow down or stop in order to keep a normal operating temperature.

In one embodiment, there may be an unmanned vehicle embargo on certain busy holiday days such as “Black Friday”. The central UTM system may arrange the movements of the unmanned vehicles as a plurality of moves like a chess player.

In some embodiments, the central server 101 or UTM system will monitor all unmanned vehicles routing in the store. Specifically, the central UTM system may need to monitor the current routes assigned to the unmanned vehicles as these change, and may remove the previous routes from the system to clean up data.

In one embodiment, the central server 101 may utilize a route forward simulation module as illustrated in the process 700 to predict and simulate the route condition based on the circumstance data. The circumstance data may include the positions and route data of all unmanned vehicles in a UTM bubble, overlapping bubbles, or another collection of unmanned vehicle presence and routing information in an area inside the store. The buffer zones or the local UTM bubbles of the unmanned vehicles may stretch into time by locally or being mapped on a central server running a forward simulation. The central server may utilize the forward simulation module to show what will happened in five, ten, fifteen or more seconds for the unmanned vehicles in an area. The central server may send alerts to the unmanned vehicle to change the routes to avoid a conflict.

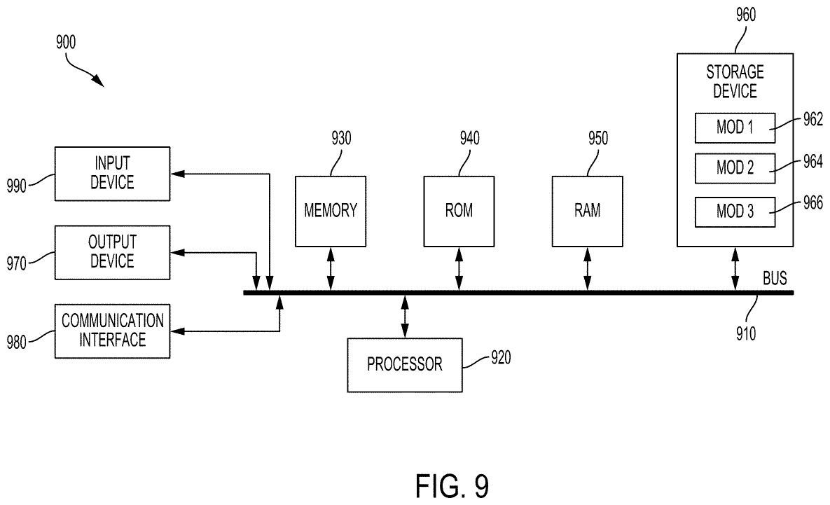

FIG. 9 illustrates an example computer system 900 which can be used to perform the systems for inventory monitoring as disclosed herein. The example computer 900 can include a processing unit (CPU or processor) 920 and a system bus 910 that couples various system components including the system memory 930 such as read only memory (ROM) 940 and random access memory (RAM) 950 to the processor 920. The system 900 can include a cache of high speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, bus 910, display 970, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 900 is a small, handheld computing device, a desktop computer, or a computer server.

Although the exemplary embodiment described herein employs the hard disk 960, other types of computer-readable media which can store data that are accessible by a computer, such as magnetic cassettes, flash memory cards, digital versatile disks, cartridges, random access memories (RAMs) 950, and read only memory (ROM) 940, may be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the embodiments and applications illustrated and described herein, and without departing from the spirit and scope of the disclosure.

1. A traffic flow managing system, comprising:
a plurality of unmanned vehicles, each of the unmanned vehicles comprising:
a processor having executable instructions stored in a non-transitory computer-readable storage medium; and
one or more sensors in communication with the processor,
wherein the processor is configured to:
detect any other unmanned vehicles approaching the unmanned vehicle within a predetermined distance via the one or more sensors,
communicate with any other unmanned vehicles to create a buffer zone around the unmanned vehicle to avoid any other unmanned vehicles from entering the buffer zone,
determine a route of the unmanned vehicle to a mission destination based on a signal received by the one or more sensors of the unmanned vehicle; and
wherein the buffer zone is determined based on at least one of a size, speed, turning radius, stopping distance, cargo dimension, cargo weight, and cargo fragility associated with the unmanned vehicle;
and when a first buffer zone of a first unmanned vehicle overlaps a second buffer zone of a second unmanned vehicle, and wherein the first unmanned vehicle and the second unmanned vehicle exchange the route data with each other and determine whether to reroute to the mission destination based on predetermined rules; and
wherein the predetermined rules comprise task priority levels associated with the plurality of the unmanned vehicles, and wherein the task priority levels comprise:
1) frozen product being transported to a customer;
2) refrigerated product being transported to the customer;
3) ambient product being transported to the customer;
4) out of Stock product being transported to sales floor;
5) returned product being transported the sales floor;
6) normal stock product being transported the sales floor;
7) floor being cleaned; and
8) normal inventory scan.

2. (canceled)

3. The system of claim 1, further comprising a central server configured to receive and update a route data from each of the unmanned vehicles, and wherein the route data comprises at least one of a GPS information, a mission destination, a task, a task priority level, a navigating speed, a mission destination, a battery level, and an operating temperature.

4. (canceled)

5. (canceled)

6. The system of claim 1, further comprising a plurality of sensors arranged in a localization grid inside a store, and wherein the plurality of sensors are configured to communicate with the one or more sensors on each of the plurality of unmanned vehicles to detect a position of each of the plurality of unmanned vehicles.

7. The system of claim 1, wherein each of the plurality of the unmanned vehicles is an unmanned aerial vehicle or an unmanned ground vehicle.

8. (canceled)

9. (canceled)

10. A traffic flow managing system, comprising:
a central server;
a plurality of sensors arranged in a localization grid inside a store;
a plurality of unmanned vehicles, each of the plurality of the unmanned vehicles comprising:
a processor having executable instructions stored in a non-transitory computer-readable storage medium; and
one or more sensors in communication with the processor, wherein the processor is configured to:
detect any other unmanned vehicles approaching the unmanned vehicle within a predetermined distance via one or more sensors,
communicate with any other unmanned vehicles to create a buffer zone around the unmanned vehicle to avoid any other unmanned vehicle from entering the buffer zone, and
determine a route of the unmanned vehicle to a mission destination based on a signal received by the one or more sensors of the unmanned vehicle; and
wherein the central server is configured to receive and update a route data from each of plurality of the unmanned vehicles, and wherein the route data comprises at least one of a GPS information, a mission destination, a task, a task priority level, a navigating speed, a mission destination, a battery level, and an operating temperature; and
wherein, when a first buffer zone of a first unmanned vehicle overlaps a second buffer zone of a second unmanned vehicle, and wherein the first unmanned vehicle and the second unmanned vehicle exchange the route data with each other and determine whether to reroute to the mission destination based on predetermined rules; and
wherein determining whether to reroute is based on predetermined rules, wherein the predetermined rules comprise a rank of the task priority levels comprising:
1) frozen product being transported to a customer;
2) refrigerated product being transported to the customer;
3) ambient product being transported to the customer;
4) out of Stock product being transported to sales floor;
5) returned product being transported the sales floor;
6) normal stock product being transported the sales floor;
7) floor being cleaned; and
8) normal inventory scan.

11. The system of claim 10, wherein the buffer zone around each of the plurality of the unmanned vehicles is determined based on at least one of a size, speed, turning radius, stopping distance, cargo dimension, cargo weight, and cargo fragility associated with the unmanned vehicles.

12. (canceled)

13. (canceled)

14. (canceled)

15. The system of claim 10, wherein the plurality of sensors arranged in the localization grid are configured to communicate with the one or more sensors on each of the plurality of the unmanned vehicles to detect a position of each of the plurality of the unmanned vehicles.

16. The system of claim 10, further comprising mounted cameras, WIFI hotspots, LTE signal boosters configured to determine areas with the most human traffic and route the plurality of the unmanned vehicles to avoid these areas.

17. The system of claim 10, wherein the central server is configured to:
maintain a database of tasks, priorities, assignments and congested aisles; and
overlay planned routes for the plurality of the unmanned vehicles and determine where an unmanned vehicle intersects with other the unmanned vehicles.

18. The system of claim 10, wherein each of the plurality of the unmanned vehicles is configured to detect and report obstacles and congestion conditions to a central server, wherein the unmanned vehicle is configured to reroute dynamically.

19. The system of claim 10, wherein each of the plurality of the unmanned vehicles has its own internal Artificial Intelligent (AI) system to enable the buffer zone.

20. The system of claim 10, wherein the central server is configured to use machine learning with a feedback loop to instruct the plurality of the unmanned vehicles to implement tasks.
